(19) United States
(12) Patent Application Publication
(10) Pub. No.: US 2013/0002926 A1
(43) Pub. Date: Jan. 3, 2013

(54) Portable Video Viewing Device

(75) Inventors: Dale Christopher Backus, Apex, NC (US); Weston Lael Phillips, Raleigh, NC (US)

(73) Assignee: SMALLHD, LLC, Cary, NC (US)

(21) Appl. No.: 13/535,592

(22) Filed: Jun. 28, 2012

Related U.S. Application Data
(60) Provisional application No. 61/503,294, filed on Jun. 30, 2011.

(51) Int. Cl. H04N 5/225

(52) U.S. Cl. 348/333.08; 348/E05.024

(57) ABSTRACT

A viewfinder employing 3-LCD technology is described which employs a dichroic prism and provides full high definition resolution with a near-to-eye display. Video from digital cinema or digital broadcast cameras, as well as, playback of recorded high definition video is supported with a viewfinder no larger than 8 inches by 4 inches by 4 inches or even smaller. A telecentric lens system may be arranged so that monochrome optical modulators or LCDs to modulate red, green and blue video, respectively, are arranged at a focal point of this lens system.

### FIELD OF THE INVENTION

The present invention relates generally to improved methods and apparatus for portable viewing, and more particularly to a high resolution viewfinder accessory.

### BACKGROUND OF THE INVENTION

FIG. 1 shows a typical 3-LCD projection system 100 for use in a video projector system. Further details of such projectors are provided by U.S. Pat. Nos. 6,957,892, 7,204,594, 7,742,028, 7,545,456, 7,443,565 and 7,714,902 assigned to Seiko Epson Corporation, all of which are incorporated by reference herein in their entirety.

The 3-LCD system 100 begins with light emitted from a single white lamp 101. The white light is then divided into its three primary colors, red, green and blue, via dichroic mirrors. Each individual light path is funneled through its corresponding grayscale LCD 102. Each LCD 102 controls the pattern of red, green or blue light passing through it and therefore creates a unique image using that specific wavelength of light. The red, green and blue images produced by the three different LCDs are then combined using a dichroic “x-cube” prism 103. The result is a full color image that may be projected onto a surface, such as a projection screen 105, utilizing additional optics 104 after the dichroic “x-cube” prism 103.

### SUMMARY OF THE INVENTION

In environments, such as movie and television filming, a true color and high definition representation of what has been or is being filmed is highly desirable and advantageous. Among its several aspects, the present invention addresses improved view finder technology for providing high definition resolution in a display device small enough to fit into a typical broadcast camera viewfinder.

A more complete understanding of the present invention, as well as further features and advantages of the invention, will be apparent from the following Detailed Description and the accompanying drawings.

### BRIEF DESCRIPTION OF THE DRAWINGS

FIG. 1 shows a prior art 3-LCD projection arrangement;

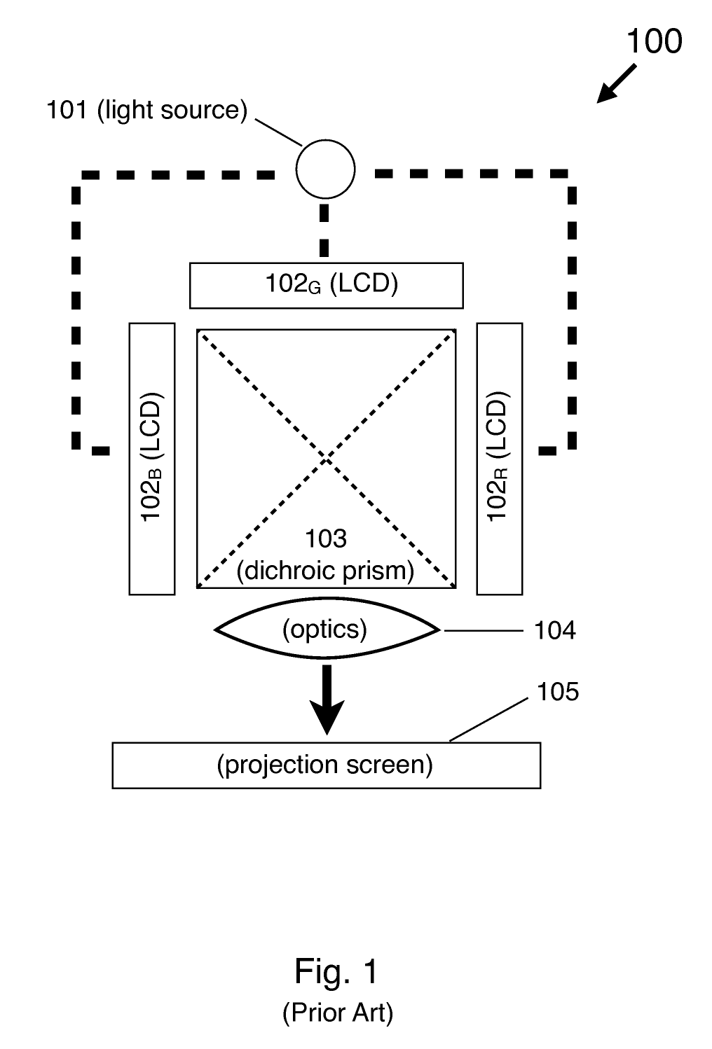

FIG. 2 shows a first embodiment of 3-LCD viewfinder optics in accordance with the present invention;

FIGS. 3A and 3B show two views of an illustrative viewfinder in accordance with the present invention incorporating the optics of FIG. 2;

FIG. 4 shows a block diagram of exemplary control electronics for the viewfinder of FIGS. 3A and 3B; and

FIG. 5 shows a flow chart of a method in accordance with the present invention.

### DETAILED DISCLOSURE

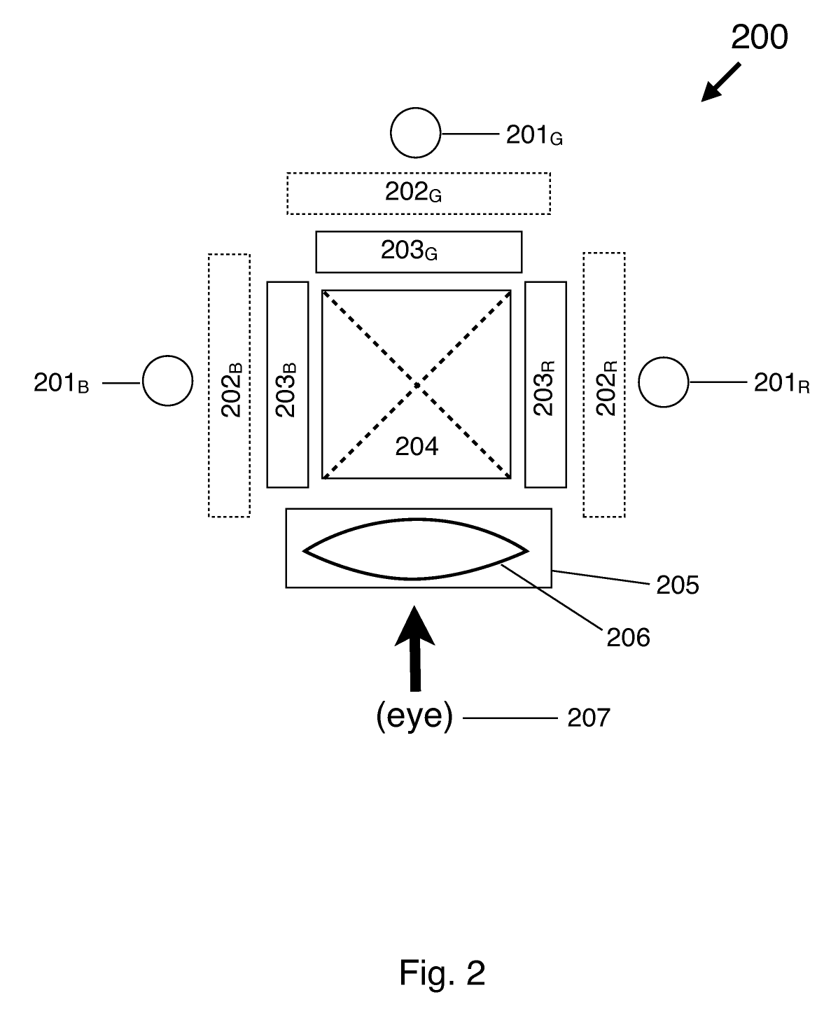

Unlike a projection system in which one looks at a projection screen, a projection surface, such as a white wall, or the like, in a viewfinder, the user looks directly into the viewfinder. To such ends, the present invention advantageously adapts a traditional 3-LCD optics arrangement into a near-to-eye display (NED) arrangement that may be advantageously incorporated into a high-resolution portable electronic viewfinder. To this end, several important design changes are made as seen in FIG. 2.

FIG. 2 shows exemplary viewfinder optics 200 in accordance with the present invention. To save space and power, separate red, green and blue light sources 201_{R}, 201_{G} and 201_{B}, such as arrays of red, green and blue light emitting diodes (LEDs), are employed. Diffused “backlight” surfaces 202_{R}, 202_{G} and 202_{B} are added between each LCD 203_{R}, 203_{G} and 203_{B} and its respective light source 201_{R}, 201_{G} and 201_{B}. This arrangement advantageously allows the individual LCDs to be driven by red, green and blue output signals from a high definition video camera used with the viewfinder of the invention either in real time or as playback from storage. While monochrome LCDs, LCD 203_{R}, 203_{G}, and 203_{B} are presently preferred, it will be recognized other electro-optical modulators may be employed to control which pixels of light are blocked and which are passed to the dichroic prism. This arrangement functions more like traditional color LCDs found in laptops, televisions, and the like, yet still employs the combination of the 3 LCDs by dichroic x-cube prism 204 to create a full color image. In use, a viewer, as represented by eye 207 looks through optics 205. Preferably, the optics 205 include a telecentric lens system 206 which produces an orthographic view of the subject being displayed. Exemplary suppliers of such lens systems include Edmund Optics and Micro Four Thirds. In the present invention, the dichroic prism 204 is arranged so that the LCDs 203_{R}, 203_{G}, and 203_{B} are at the focal point of the telecentric lens system 206 of optics 205, and thus become the focal point for the operator's eye 207. This near-to-eye 3-LCD arrangement advantageously allows the operator to see a full color image by looking directly into the 3-LCD cube system rather than looking at a surface or screen on which the 3-LCD system is projecting its image.

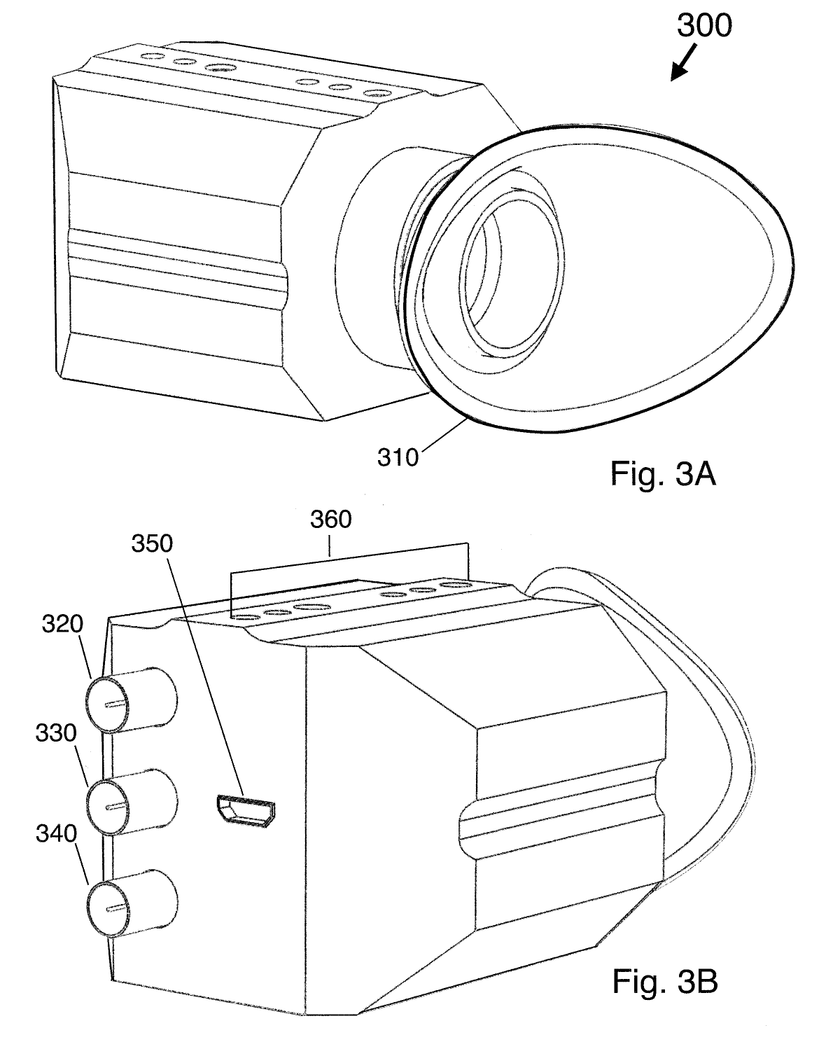

The viewfinder optics 200 may suitably to be employed in a viewfinder 300 shown in FIGS. 3A and 3B to implement a high definition (HD) high resolution viewfinder accessory for use in conjunction with digital cinema or digital broadcast cameras, as well as, playback of recorded high definition video. As seen in FIG. 3A, viewfinder 300 may include standardized broadcast and commercial video inputs including, but not limited to, serial digital interface (SDI) 320, composite video including color, video blanking and sync signals (CVBS) 330, and high-definition multimedia interface (HDMI) 350. Additionally, FIG. 3B shows a communication interface 340 for communication with a high definition video camera, input of previously recorded video, or the like. Additionally, viewfinder 300 includes plural control buttons (collectively 360). While an exemplary arrangement is shown, it will be recognized other interfaces and control button arrangements may be suitably employed as desired for a particular mount, context or application. Implementing 3-LCD technology, the viewfinder 300 will preferably have a size of no larger than 8 inches by 4 inches by 4 inches. Even more preferably, the viewfinder 300 will be embodied in a smaller package than that, and close to the actual size illustrated in FIGS. 3A and 3B. A preferred device will be roughly the size of a viewfinder found on a large shoulder-mounted broadcast camera. The present invention advantageously provides full high definition resolution (1080p or higher) in a display device small enough to fit into a package the size of a typical broadcast or digital cinema camera's viewfinder or smaller. 1080p is a video mode characterized by 1080 lines of vertical resolution and progressive scan and is sometimes referred to as full HD. With an aspect ratio of 16:9, a resolution of 1920×1080 pixels or 2.1 megapixels is provided.

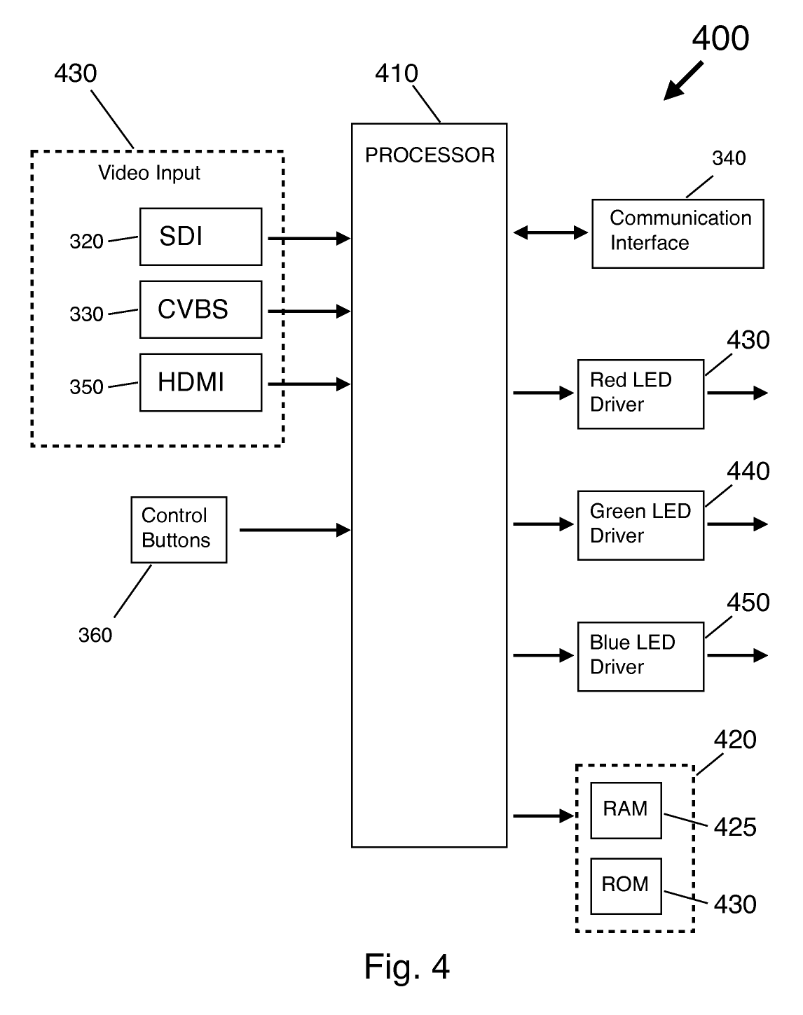

FIG. 4 illustrates an exemplary control system 400 for the viewfinder 300. As seen in FIG. 4, a suitably programmed microprocessor 410 has associated memory 420 including RAM 425 and ROM 430 for storing data and program instructions. The processor 410 receives video input 430 from video source inputs 320, 330 and 350, for example, as well as control inputs from control buttons 360 for functions such as video playback, zebra exposure filter, focus assist filter, frame guide filter, and the like. Communication with a camera mount is also suitably conducted by controlling communication interface 340. Alternatively, recorded video may be input utilizing interface 340. Additionally, processor 410 controllably drives LCDs 203_{R}, 203_{G}, and 203_{B} utilizing drivers 440, 450 and 460, respectively.

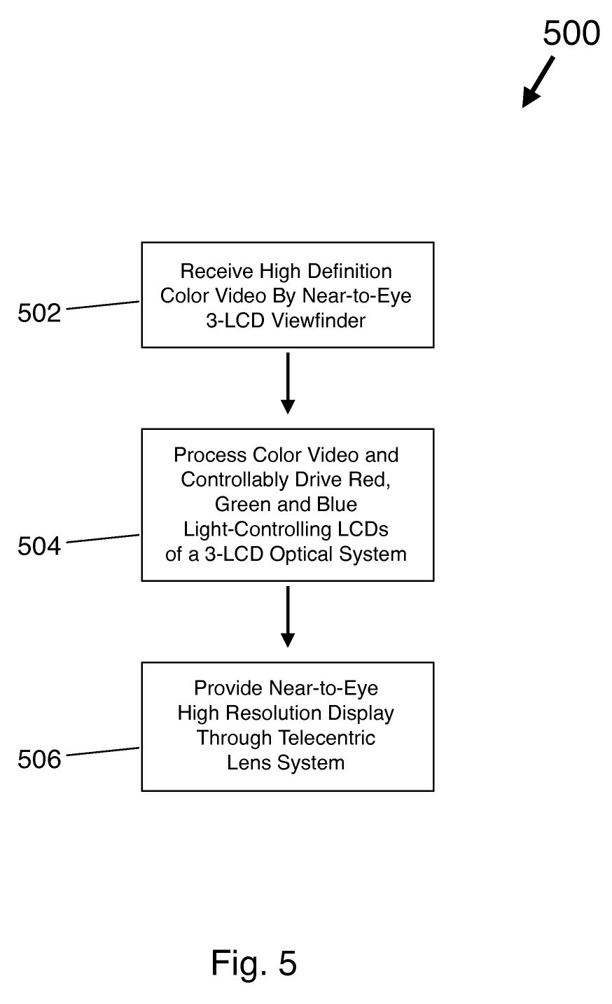

FIG. 5 illustrates a method 500 in accordance with the present invention. In step 502, a near to eye 3-LCD viewfinder in accordance with the present invention, such as viewfinder 300 of FIGS. 3A and 3B receive high definition color video. For example, 1080p video signals may be received in real time on inputs 320, and 350. Alternatively, pre-recorded color video may be received.

In step 504, the video signals from step 502 are processed and separated into red, green and blue color channels and used to controllably drive red, green and blue light controlling LCDs of a 3-LCD system such as shown in FIG. 2, for example.

In step 506, a high resolution near-to-eye display is provided through a telecentric lens system.

While the present invention is disclosed in the context of a presently preferred embodiment, it will be recognized that a wide variety of implementations may be employed by persons of ordinary skill in the art consistent with the above discussion and the claims which follow below.

We claim:

1. A viewfinder optical apparatus comprising:
three light source devices that emit substantially parallel luminous flux to a side of a region to be illuminated;
three electro-optic modulators that modulate the luminous flux coming from the three illumination devices in accordance with image information;
three light diffusion layers each of which is disposed between one of the three electro-optic modulators and its respective light source device;
a dichroic prism; and
viewfinder optics.

2. The use of the viewfinder optical apparatus of claim 1 in a viewfinder-style video viewing device.

3. The viewfinder optical apparatus of claim 1 wherein the electro-optic modulators comprise monochrome LCDs.

4. The viewfinder optical apparatus of claim 1 wherein the viewfinder optics comprise a telecentric lens system.

5. The viewfinder optical apparatus of claim 1 wherein the telecentric lens system is arranged whereby the monochrome LCDs are arranged at a focal point of the telecentric lens system.

6. The viewfinder optical apparatus of claim 5 further comprising a video input for receiving video input from a high definition video camera.

7. The viewfinder optical apparatus of claim 6 wherein the three light source devices comprise an array of red LEDs, an array of green LEDs, and an array of blue LEDs.

8. The viewfinder optical apparatus of claim 7 further comprising:
drivers for driving the monochrome LCDs; and
a processor for processing the video input and controlling the drivers.

9. The viewfinder optical apparatus of claim 1 further comprising a portable housing containing the viewfinder optical apparatus components and having overall dimensions of 8 inches by 4 inches by 4 inches or less.

10. The viewfinder optical apparatus of claim 9 providing full high definition resolution of 1080p or better.

11. The viewfinder optical apparatus of claim 1 further comprising:
control buttons to control video playback.

12. A method of displaying high definition video in a viewfinder optical apparatus comprising:
emitting substantially parallel luminous flux on each of three sides of a region to be illuminated utilizing three light source devices;
modulating the luminous flux coming from the three illumination devices utilizing three electro-optic modulators in accordance with image information from the high definition video;
employing three light diffusion layers each of which is disposed between one of the three electro-optic modulators and its respective light source device;
combining light outputs from the electro-optic modulators utilizing a dichroic prism; and
displaying an output display employing viewfinder optics.

13. The method of claim 12 wherein the viewfinder optics comprise a telecentric lens system.

14. The method of claim 12 wherein the telecentric lens system is arranged whereby the monochrome LCDs are arranged at a focal point of the telecentric lens system.

15. The method of claim 12 further comprising:
receiving video input from a high definition video camera.

16. The method of claim 13 wherein the three light source devices comprise an array of red LEDs, an array of green LEDs, and an array of blue LEDs.

17. The method of claim 16 further comprising:
driving the monochrome LCDs utilizing outputs of a processor for processing the video input and producing control signals to control the drivers.

18. The method of claim 12 further comprising:
housing the viewfinder optical apparatus components in a housing having overall dimensions of 8 inches by 4 inches by 4 inches or less.

19. The method of claim 18 further comprising:
providing full high definition resolution of 1080p or better.

20. The method claim 12 further comprising:
controlling video playback.
